(19) United States
(12) Patent Application Publication
(10) Pub. No.: US 2005/0049730 A1
(43) Pub. Date: Mar. 3, 2005

(54) Keypad for building automation

(76) Inventors: Hugh P. Adamson, Boulder, CO (US); Scott Hesse, Longmont, CO (US); William Nicolay, Loveland, CO (US); William T. Beierwaltes, Loveland, CO (US)

Correspondence Address: Mark D. Trenner;Trenner Law Firm, LLC, 12081 W. Alameda Pkwy #163, Lakewood, CO, 80228, US

(21) Appl. No.: 10/929,076

(22) Filed: Aug. 27, 2004

Related U.S. Application Data
(60) Provisional application No. 60/499,226, filed on Aug. 29, 2003.

(51) Int. Cl. G05B 15/00; G05B 11/01

(52) U.S. Cl. 700/83; 715/968

(57) ABSTRACT

Keypads for building automation systems are described and claimed herein. An exemplary implementation of a keypad device comprises a keypad circuit and a processor operatively associated with computer readable storage. A keypad program resides in the computer readable storage and is executable by the processor to generate signals identifying input at the keypad circuit and to issue the signals to automation devices in the building automation system.

### PRIORITY AND RELATED APPLICATIONS

This application claims priority to co-owned U.S. Provisional Patent Application Ser. No. 60/499,226 for “Keypad for Building Automation” of Adamson, et al. (Attorney Docket No. CVN.010.PRV), filed Aug. 29, 2003, hereby incorporated herein for all that it discloses.

This application is also related to co-owned U.S. patent application Ser. No. 10/793,596 for “Keypad Device and Methods of Operation” of Beierwaltes, et al. (Attorney Docket No. CVN.016.USP), filed Mar. 3, 2004.

### TECHNICAL FIELD

The described subject matter relates to building automation, and more particularly to keypads for building automation systems.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Low-end building automation systems are typically provided with switches, dials and knobs for controlling specific automation devices in a prescribed manner and cannot be readily customized or changed for individual users. More sophisticated building automation systems may use computer controls. These computer controls may be daunting to the user and therefore the user fails to realize the full potential of the building automation system. If these computer controls fail, the user may be unable to use all or part of the building automation system. An electrician typically needs to make a house call, shut power to the entire building automation system, and replace the device.

### SUMMARY

Implementations of keypads for building automation systems are described herein. In an exemplary implementation, a keypad is provided comprising a keypad circuit and a processor operatively associated with computer readable storage. A keypad program resides in the computer readable storage and is executable by the processor to generate signals identifying input at the keypad circuit and to issue the signals to automation devices in the building automation system.

In another exemplary implementation, a method to issue commands from a keypad device is provided. The method may include: initialing a keypad circuit, receiving keypad input at a processor from a keypad circuit, generating a signal at the processor identifying the keypad input, and issuing the signal identifying the keypad input to at least one automation device in the building automation system.

In another exemplary implementation, a method of programming a keypad device for use in a building automation system is provided. The method may include: identifying a button for programming, entering a programming mode, associating the identified button with at least one automation device in the building automation system, associating the identified button with at least one device function, and writing a keypad program executable by a processor at the keypad device to generate signals for the at least one automation device to perform the at least one device function when the identified button is activated.

### BRIEF DESCRIPTION OF THE DRAWINGS

FIG. 1 is an illustration of an exemplary building automation system in which keypad device may be implemented.

FIG. 2 is a front plan view of an exemplary keypad device.

FIG. 3 is a back plan view of the exemplary keypad device shown in FIG. 2.

FIG. 4 illustrates exemplary functional components of a keypad device.

FIG. 5 is an exemplary implementation of a keypad circuit

FIG. 6 illustrates operations 600 to generate or update a keypad program for a keypad device.

FIG. 7 illustrates operations 700 to issue commands from a keypad device to an automation device in a building automation system.

### DETAILED DESCRIPTION

A keypad device may replace conventional light switches or other controllers and facilitates user control of automation devices in a building automation system. The keypad device may be customized for the user by generating a keypad program. A backup copy of the keypad program can be maintained onsite and/or at a remote site and replacement keypad devices may be automatically assigned the prior keypad's network ID and loaded with the current keypad program.

The user or a technician may program any key function onsite or remotely and in real time (e.g., via an external link to the building automation system). For example, the user may call a technician to make changes to a keypad program. Once the owner approves the changed functionality of the keypad, the new keypad program may be loaded into the keypad.

In addition, the keypad circuitry operates on low voltage power which may be provided over the data cable. Such an implementation eliminates the need for electrician labor, and allows for fast, simple, and inexpensive installations, e.g., by low-voltage installers. The keypad device may also be “hot-swapped” without having to remove power to the building automation system.

The keypad device also comprises robust self-diagnostics to detect warning signs for failures or potential failures. If a problem is detected, an email can be automatically launched by the building automation system to a technician explaining the problem. Accordingly, issues can be detected and corrected before the building owner ever recognizes that there is a problem.

Exemplary System

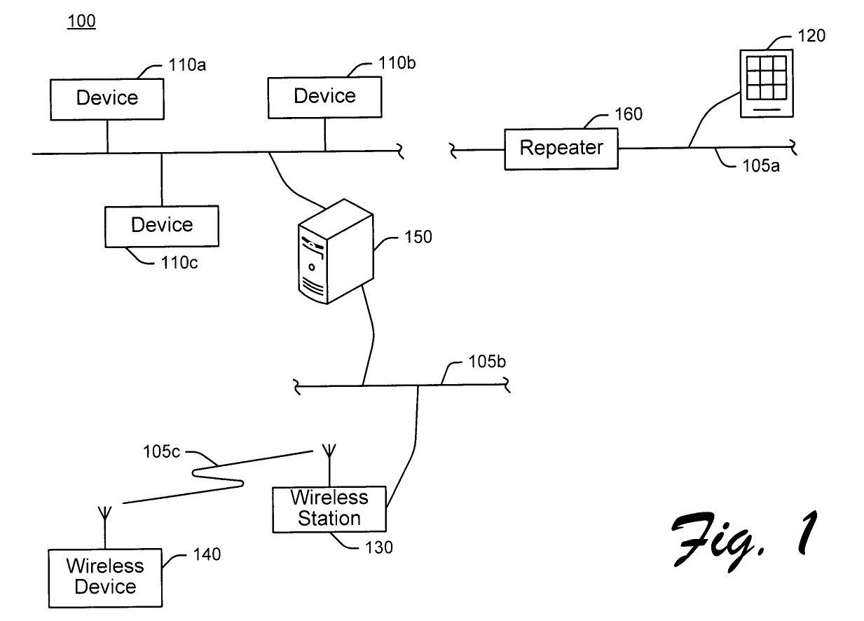

An exemplary building automation system 100 is shown in FIG. 1 as it may be used to automate various functions in a home or other building (e.g., apartment complex, hotel, office building). By way of example, the building automation system 100 may be used to control lighting, heating, air conditioning, audio/visual distribution, operating window coverings to open/close, and security, to name only a few examples.

Building automation system 100 may include one or more automation devices 110a-c (hereinafter generally referred to as automation devices 110). The automation devices 110 may include any of a wide range of types and configurations of devices. Examples include, e.g., security sensors, temperature sensors, light sensors, timers, touch pads, and voice recognition devices, to name only a few.

For purposes of illustration, automation devices 110 may include a keypad 120, a wireless station 130, and a wireless device 140. The keypad 120 may be communicatively coupled over one or more networks 105a-c to the wireless station 130 which in turn can be wirelessly coupled to the wireless device 140 (e.g., via an RF connection).

Before continuing it is noted that the devices 110 (including keypad 120) may be coupled to the network and/or to other devices by hardwiring and/or remote link (e.g., an IR connection). It is also noted that the keypad 120 is not limited to use with any particular devices, nor is the keypad 120 limited to use with wireless devices. For example, the keypad 120 may also be used with other keypads in the building automation system 100.

Automation devices 110 may be communicatively coupled to one another via wired networks 105a-b and/or wireless networks 105c. In an exemplary implementation, keypad 120 is coupled to a controller area network (CAN) bus. Use of automation devices 110 (such as a keypad on a CAN bus) are described in more detail in co-owned U.S. patent application Ser. No. 10/382,979, entitled “Building Automation System and Method” of Hesse, et al. filed on Mar. 5, 2003.

Briefly, the CAN bus may be implemented using a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second kbits/s). It is also a robust bus and can be operated in noisy electrical environments while maintaining the integrity of the data.

It is noted, however, that the keypad 120 is not limited to use with a CAN bus. Indeed, the keypad 120 may be communicatively coupled to different types of networks. Accordingly, building automation system 100 may also include one or more optional bridges 150 to facilitate communications between different types of networks (e.g., between a CAN bus and an Ethernet).

The term “bridge” as used herein refers to both the hardware and software (the entire computer system) and may be implemented as one or more computing systems, such as a server computer. It is noted therefore that the bridge 150 may also perform various other services for the building automation system 100. For example, bridge 150 may be implemented as a server computer to process commands for automation devices 110, provide Internet and email services, broker security, and optionally provide remote access to the building automation system 100.

Bridge 150 may also be implemented to store a backup copy of each keypad program. If a keypad 120 is replaced, the keypad program may be automatically reloaded to eliminate time-consuming and tedious programming by the installer. The bridge 150 may also download other program code (e.g., scripts or firmware) for the keypad 120. The keypad 120 may also report problems or data collection to the bridge 150 for use in the building automation system.

Building automation network 100 may also include one or more optional repeaters 160, e.g., to extend the physical length of the network, and/or to increase the number of devices that can be provided in the building automation system 100. For example, repeater 160 may be implemented as the physical layer to amplify signals and/or improve the signal to noise ratio of the issued signals in the building automation network 100. Repeater 160 may also be implemented at a higher layer to receive, rebuild, and repeat messages.

It is noted that the building automation system 100 is not limited to any particular type or configuration. The foregoing example is provided in order to better understand one type of building automation network in which the keypad device and methods described herein may be implemented. However, the lighting control systems and methods may also be implemented in other types of building automation systems. The particular configuration may depend in part on design considerations, which can be readily defined and implemented by one having ordinary skill in the art after having become familiar with the teachings of the invention.

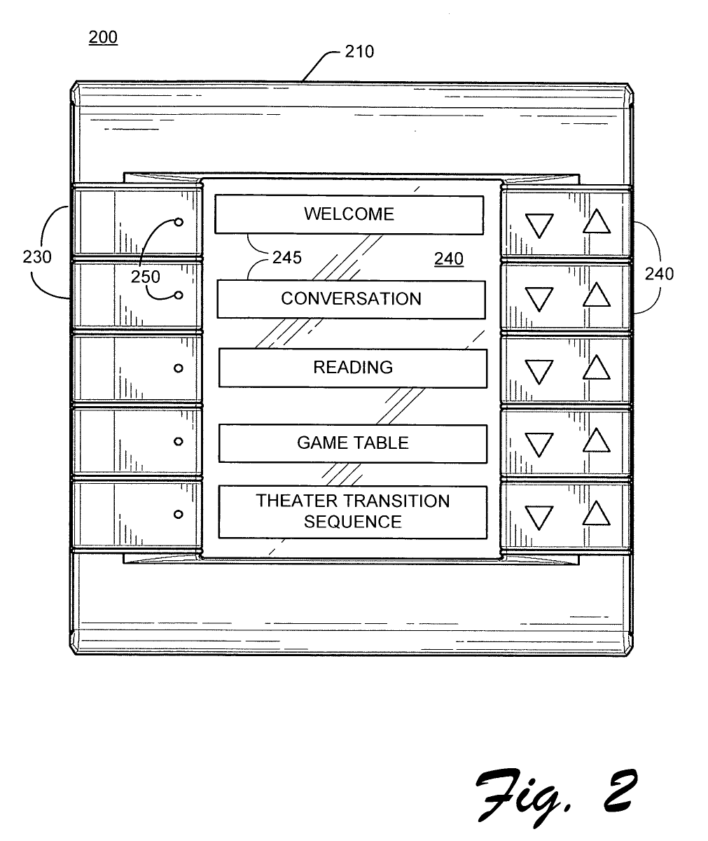

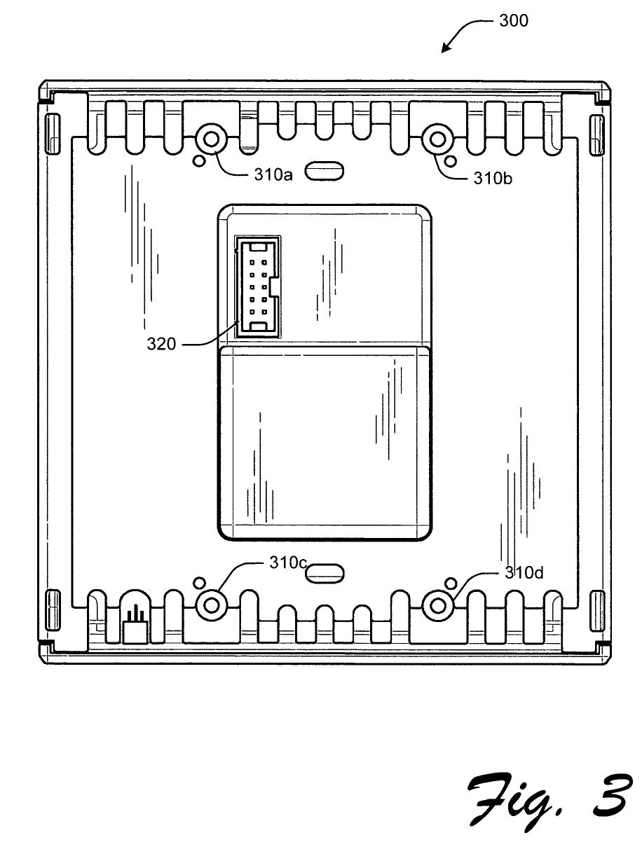

FIGS. 2 and 3 show front and rear views of an exemplary keypad that may be implemented in a building automation system. FIG. 2 is front plan view of keypad device 200. Keypad device 200 may include a housing 210 defining a label area 220. Labels 245 may be used to identify the functions that can be controlled by the keypad 200. Readily understood labels may be used. For example, lighting schemes may be labeled as Welcome, Conversation, Reading, Game Table, and Deck Landscaping, Fireplace, and Theater Transition Sequence (e.g., a dimming scheme).

Keypad 200 may also include function buttons 230 and corresponding adjustment buttons 240. Adjustment buttons 240 may be implemented as rocker switches to implement adjustment (e.g., increasing/decrease) and/or scrolling capability.

Buttons 230, 240 may be implemented as magnetic switch elements to provide a quick response and positive feel when a button is pressed. Magnetic switches are readily commercially available, for example, from Duraswitch Industries, Inc. (Mesa, Ariz. 85210). Alternatively dome switches or any other type of contact switch may be implemented to sense an input, e.g., by way of pressure, capacitance, magnetism, etc.

Function buttons 230 may be activated to select a function. For example, function buttons may be used to select lighting controls or multimedia controls, to name only a few exemplary functions. Adjustment buttons 240 may then be used to make adjustments to the selected function. For example, the user may dim the lighting, raise and lower the volume for the sound system, or open/close curtains. Or for example, the user may scroll through predetermined lighting schemes (e.g., party mode, reading mode), or select a type of music (e.g., party mix, relaxation).

Keypad device 200 may also include indicators 250 implemented as, e.g., LEDs, incandescent lights, speakers. Indicators 250 may provide positive feedback to the user, such as to indicate when a function is received and/or executed by an automation device. For example, the keypad 200 may issue a signal to an automation device when the user presses one or more of the buttons 230, 240. The automation device may in turn issue a reply to the keypad 200 whereupon the indicator 250 may be activated or lit. Indicator(s) 250 may also be activated on one or more other keypads (e.g., on the other side of the same room). The indicator 250 may be also be deactivated, e.g., in response to an instruction from the automation device, after a predetermined time, etc.

Keypad 200 may also include a luminescent web 260 between buttons 230, 240. The luminescent web 260 may illuminate the keypad 200 so that the keypad can be found in a dark room. The luminescence may be derived from a luminescent pigment molded into the web plastic. Alternatively, the luminescent web 260 may be illuminated using a light source, e.g., provided behind a translucent material.

FIG. 3 is a back plan view of the exemplary keypad device shown in FIG. 2. A backplate 300 may be provided for mounting a PC board (not shown) with control circuitry to the keypad housing. The backplate 300 may be mounted to a wall or other surface, e.g., with screws provided through holes 310a-d formed in backplate 300. Keypad device may also include a connector 320 for coupling to a building automation network. Power for the keypad device may also be provided via connector 320.

It is noted that the keypad device shown and described with reference to FIGS. 2 and 3 is merely illustrative of an exemplary keypad device. Other implementations are also contemplated and are not limited to any particular configuration. For example, the keypad device may be implemented as a thin film transistor (TFT) device, wherein touch sensitive controls or “buttons” are displayed as graphical icons or text on a TFT screen. Commercially available touch-sensitive techniques include resistive circuitry wherein pressure is required to short spaced membranes, and capacitive circuitry wherein pressure is not required and instead a connection to the body de-tunes the capacitance. The icons may be selected using a pointing device (e.g., a stile) or the user may simply touch the TFT screen with his or her finger.

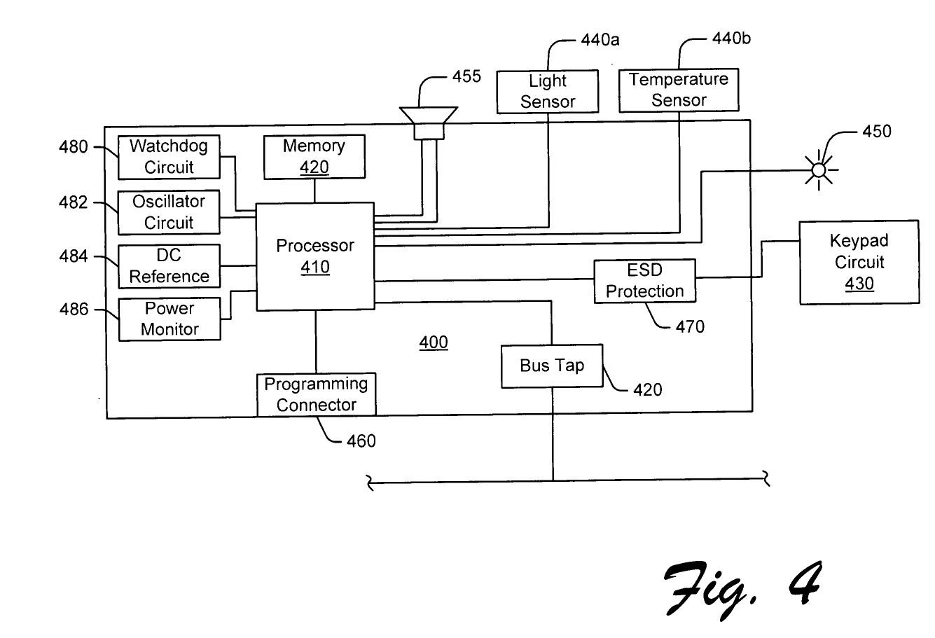

FIG. 4 illustrates exemplary functional components of a keypad device. Keypad device 400 may include a processor (or processing units) 410. Processor 410 may be communicatively coupled to a building automation network via a connector such as bus tap 420, e.g., to send and receive control signals and/or data signals embodied as carrier waves. Processor 410 may also be operatively associated with computer-readable storage 420. Computer-readable storage 420 may include, e.g., non-volatile memory such as FLASH memory and/or battery-backed SRAM.

Processor 410 may be operatively associated with a keypad circuit 430 for receiving input from the keypad buttons. Keypad circuit 430 signals the processor 410 based on user input (e.g., depressing or releasing a button). A two-stage electrostatic discharge protection (ESD) circuit 470 may also be provided between the keypad circuit and the processor 410 to protect the processor against static electricity build-up at the keypad buttons.

Processor 410 may also receive input from external sources, such as, e.g., light sensor 440a, temperature sensor 440b. Input from the external sources may be used in combination with user-selected functions and/or adjustments using the keypad buttons. For example, illumination level data for a room may be provided by the light sensor 440a to adjust the lighting intensity for a particular user-selected lighting scheme. In another example, the processor 410 may use the illumination level data to adjust the LED intensity (e.g., brighter during daylight and dimmer in the dark).

Other types of sensors and/or data devices (not shown) may also be provided, including but not limited to temperature sensors, clocks, and electronic calendars. Sensor data may also be used by other devices in the building automation system. For example, temperature data may be relayed from the keypad via the bridge to a climate control device.

In addition, output devices may also be operatively associated with the keypad device 400. For example, LEDs 450 may be provided adjacent the keypad buttons as described above. As another example, an optional sounder 445 (e.g., piezo, speaker, etc.) may also be provided for audible feedback, e.g., when the user presses a button.

Processor 410 may be implemented to execute computer-readable program code (stored on computer-readable storage 420) in response to input received at the keypad, e.g., from the keypad circuit 430, sensors 440, and/or external input from another device or the bridge.

Processor 410 may execute computer-readable program code (e.g., the “keypad program”) for controlling one or more automation devices in the building automation system. In an exemplary implementation, the processor 410 may execute program code for identifying one or more automation devices associated with one or more buttons on the keypad device 400. Processor 410 may also execute computer-readable program code for generating and issuing device commands to automation device(s) based input at the keypad device 400.

Alternatively, Processor 410 may execute computer-readable program code for generating and issuing an event notification to an automation device. An event notification identifies an event at the keypad such as, e.g., a key press, a key release, or input received from a sensor or other device in the building automation system. When the event notification is received by an automation device, program code may be executed at the automation device to perform one or more functions corresponding to the event. For example, the automation devices may open/close curtains, execute a lighting scheme, etc. in response to an event at the keypad.

Computer readable program code may be implemented as scripts. Scripts are computer-readable program code optimized for programmer efficiency (e.g., it is relatively easy to write, flexible, and readily modified). Scripts are preferably independent of the type of processor and/or operating system and are therefore portable to a variety of different environments.

Exemplary implementations of scripts used in building automation systems are described in co-owned U.S. patent application Ser. No. 10/422,525 to Kiwimagi, et al., and entitled “Distributed Control Systems and Methods.” However, it is noted that the computer-readable program code is not limited to scripts, and other implementations of program code now known or later developed may also be used.

Keypad device 400 may be programmed, e.g., by a technician using a programming connector 460 for a laptop computer or other programming device. Optional programming is also available at the keypad using the keypad buttons. In an exemplary implementation, the keypad can enter a programming mode by pressing and holding a button. In programming mode the user may operate the up/down buttons to adjust maximum and minimum settings.

The keypad program may then be written to non-volatile memory. The keypad program can also be delivered to other keypad devices, for example, so that all keypads will have the same LED brightness or to avoid the need for duplicate programming. As mentioned above, the keypad program may also be stored at the bridge.

Other local and/or global features can also be programmed at the keypad using the programming connector and/or keypad buttons (e.g., to reset automation devices).

Keypad device 400 may also include robust self-diagnostics to detect warning signs for failures or potential failures. In an exemplary implementation, kaypad device 400 may include an optional watchdog circuit 480, oscillator circuit 482, DC reference circuit 484, and power monitor circuit 486 operatively associated with the processor 410.

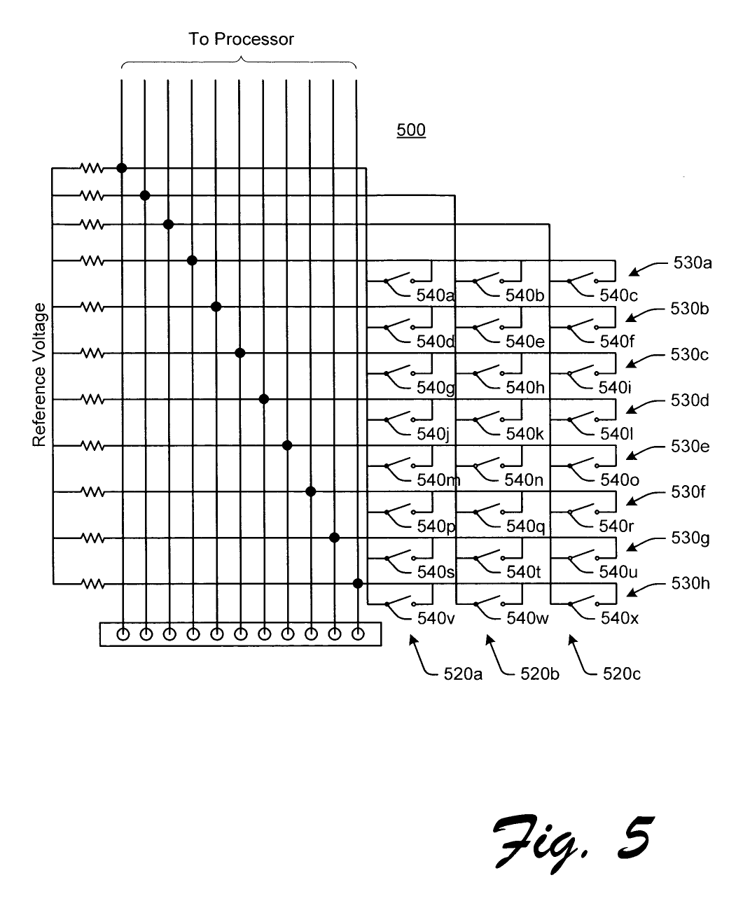

FIG. 5 is an exemplary implementation of a keypad circuit. Exemplary keypad circuit 500 includes a switching grid 510. Switching grid 510 receives user input (e.g., when a button on the keypad is pressed or released) and issues corresponding signal(s) identifying the user input to a processor at the keypad device.

Switching grid 510 may include switching arranged in 3 columns 520a-c and 8 rows 530a-h, providing 11 lines to the processor. Each line can be switched between input and output lines which the processor can use as a logic table to isolate the switch which is activated (e.g., open or closed).

By way of illustration, each column 520a-c may be initially set as an output line by carrying a high signal from the processor and each row 530a-h may be initially set as an input line to the processor. If one of the switches is activated (e.g., if Switch 540a is closed), the high signal from the first column 520a is connected to the first row 530a and the processor receives a high signal from the first row indicating that one of the switches in the first row is closed.

To isolate which of the switches in the first row is closed the processor changes the rows 530a-h to output lines and the columns 520a-c to input lines. Each row 520a-c now carries a high signal from the processor. This changeover occurs quickly (i.e., before the user can open the switch). Because Switch 540a is still activated, the high signal from the first row 530a is connected to the first column 520a and the processor receives a high signal on the input line from the first column 520a indicating that the switch in Row 1 and Column 1 (i.e., Switch 540a) is active.

It is noted that the above example is provided merely as an illustration of a keypad circuit. Other keypad circuits may include any number of rows and columns and may use other operations for isolating an active switch.

Exemplary Operations

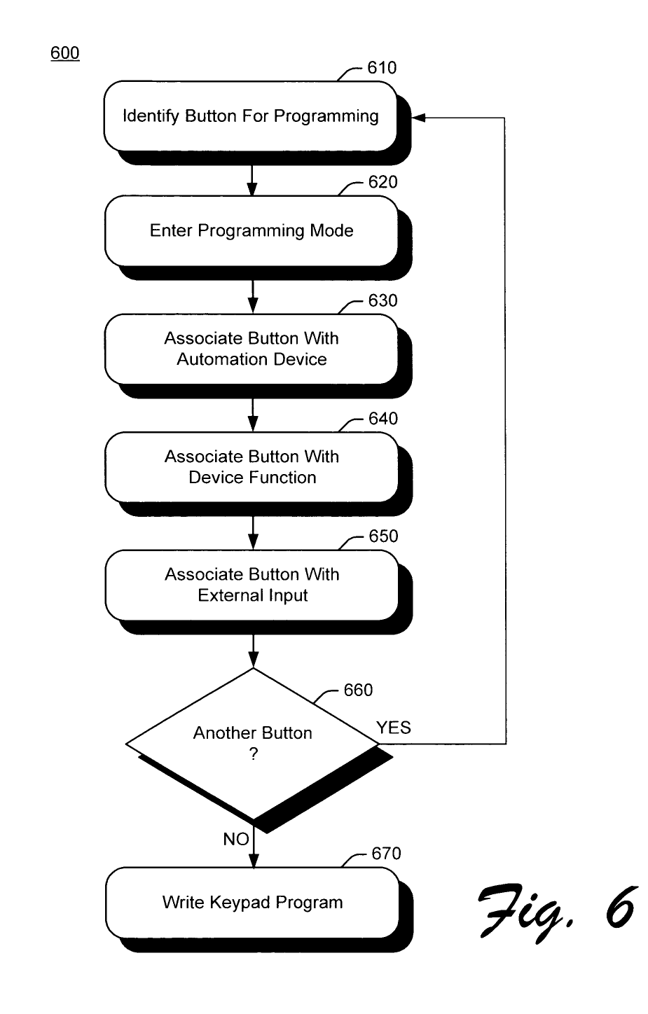

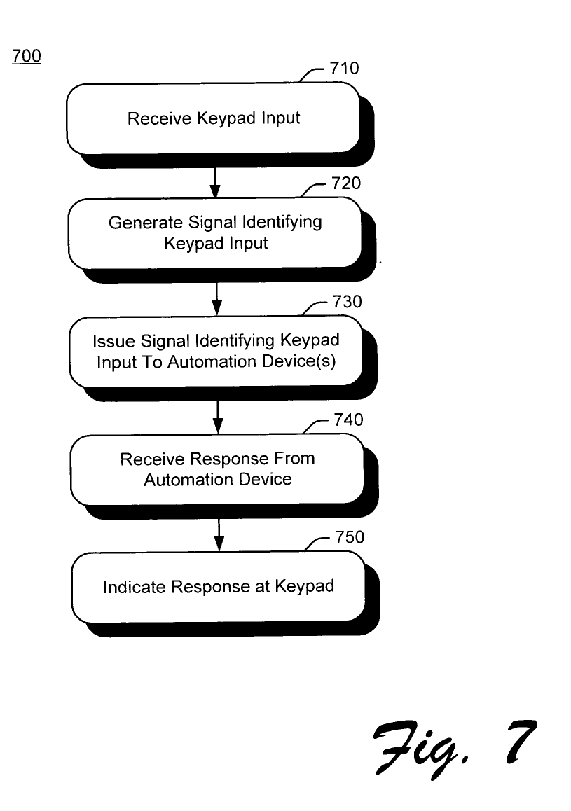

FIGS. 6 and 7 are flow charts of operations that may be implemented by an exemplary keypad device. In an exemplary implementation, the operations may be implemented by computer-readable program code stored in computer-readable storage and executed on a processor (or processing units) at a keypad device, such as the keypad device 400 shown in FIG. 4.

FIG. 6 illustrates operations 600 to generate or update a keypad program for a keypad device. In operation 610 one or more buttons is identified to be programmed. For example, a user may press a function button on the keypad device, thereby selecting the function button and corresponding adjustment buttons. Alternatively, a technician may identify one or more buttons on the keypad device. In operation 620 the keypad device enters a programming mode. In operation 630 the selected button(s) is associated with an automation device. For example, the selected function button may be associated with a lighting controller in the building automation system. In operation 640 one or more of the selected buttons is associated with a function and/or adjustments to a function (e.g., for raising/dimming lighting in a room). In operation 650 external inputs, if any, may be associated with the selected button. For example, input from a photocell in the room may be used to supplement a lighting scheme in the room.

In operation 660 another button or set of buttons may be programmed by returning to operation 610. In operation 670 the keypad program is stored, e.g., in non-volatile memory at the keypad. Optionally a backup copy of the keypad program may be stored at the bridge and/or offsite.

FIG. 7 illustrates operations 700 to issue commands from a keypad device to an automation device in a building automation system. In operation 710 a processor at the keypad receives input, e.g., from one of the keypad buttons and/or external source. In operation 720 the processor generates a signal identifying the input. For example, the signal may identify which button(s) were pressed by the user. In operation 730 the signal is issued to one or more automation devices. For example, the signal may be broadcast to all automation devices in the network, or addressed to specific automation devices in the network. In operation 740, the keypad device receives a response from the automation devices indicating that a command corresponding to the issued signal is executing or has been executed. In operation 750 the processor may indicate to the user the keypad status. For example, an LED may light to indicate the function is executing or has been executed.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A keypad device for a building automation system comprising:
a keypad circuit;
a plurality of keypad buttons and at least one sensor operatively associated with the keypad circuit;
a processor operatively associated with computer readable storage;
a keypad program residing in the computer readable storage and executable by the processor to generate signals identifying input at the keypad circuit from the keypad buttons and at least one sensor and to issue the signals to automation devices in the building automation system.

2. The keypad device of claim 1, wherein the keypad circuit includes a switching grid for determining by the processor which of the plurality of keypad buttons is activated.

3. The keypad device of claim 1, further comprising a remote connection to a network in the building automation system.

4. The keypad device of claim 1, further comprising a connection to a CAN bus network in the building automation system.

5. The keypad device of claim 1, further comprising a watchdog circuit operatively associated the processor for self-diagnostics.

6. The keypad device of claim 1, further comprising a power monitor operatively associated the processor for self-diagnostics.

7. The keypad device of claim 1, at least one LED status indicator operatively associated with the keypad circuit to indicate a response to input received at the keypad circuit.

8. The keypad device of claim 1, wherein the processor issues input from the at least one sensor to other automation devices in the building automation system.

9. A method to issue commands from a keypad device in a building automation system comprising:
initialing a keypad circuit;
receiving keypad input at a processor from a keypad circuit;
generating a signal at the processor identifying the keypad input;
issuing the signal identifying the keypad input to at least one automation device in the building automation system.

10. The method of claim 9 further comprising receiving a response from the at least one automation device.

11. The method of claim 10 further comprising indicating the response for a user at the keypad device.

12. The method of claim 10 further comprising setting each column in a switching grid of the keypad circuit as an output line from the processor and each row in the switching grid of the keypad circuit as an input line to the processor.

13. The method of claim 10 wherein initializing the keypad circuit includes setting each column in a switching grid of the keypad circuit as an output line from the processor and each row in the switching grid of the keypad circuit as an input line to the processor.

14. The method of claim 13 further comprising changing each column in the switching grid of the keypad circuit to an input line to the processor and each row in the switching grid of the keypad circuit to an output line from the processor to isolate an activated button in the switching grid of the keypad circuit.

15. The method of claim 14 wherein changing each column and grid occurs before the activated button is deactivated.

16. A method of programming a keypad device for use in a building automation system comprising:
identifying a button for programming;
entering a programming mode;
associating the identified button with at least one automation device in the building automation system;
associating the identified button with at least one device function;
writing a keypad program executable by a processor at the keypad device to generate signals for the at least one automation device to perform the at least one device function when the identified button is activated.

17. The method of claim 16, further comprising storing a backup copy of the keypad program at a bridge in the building automation system.

18. The method of claim 16, further comprising retrieving a backup copy of the keypad program for use by a replacement keypad in the building automation system.

19. The method of claim 16, further comprising updating the keypad program from an offsite location.

20. The method of claim 16, further comprising associating external input with the identified button.
